(19) United States
(12) Patent Application Publication
(10) Pub. No.: US 2012/0139687 A1
(43) Pub. Date: Jun. 7, 2012

(54) HIGH POWER FUSE

(76) Inventors: Adrian Traian Plesca, Lasi (RO); Codrin-Gruie Cantemir, Columbus, OH (US)

(21) Appl. No.: 13/308,615

(22) Filed: Dec. 1, 2011

Related U.S. Application Data
(60) Provisional application No. 61/418,426, filed on Dec. 1, 2010.

(51) Int. Cl. H01H 85/00

(52) U.S. Cl. 337/142

(57) ABSTRACT

An electric fuse comprising two fuse links connected in parallel. Each fuse link includes a central portion, a first terminal portion, a second terminal portion on the opposite end of the central portion, the fuse link having a first surface, and a second surface opposite of the first surface. The fuse links are connected in parallel. Springs are tensioned on the fuse links, engaged with the central portion and the first terminal portion tensioned to separate the top fuse surface from the fusible element during short circuit. The interior surfaces of the fuse links are coated with a tin alloy to prevent oxidation of the operative surface.

### CROSS-REFERENCE TO RELATED APPLICATIONS

This provisional patent application makes no claim of priority to any earlier filings.

### TECHNICAL FIELD

The disclosed embodiments are in the field of electrical circuit fuses, and more particularly to fuses for high-power or direct current applications.

### BACKGROUND OF THE ART

Fuses for use in DC applications have received increased attention in recent years due to the demand for applications that use high powered batteries, electric and hybrid cars are one example. In the past, fuses developed for AC circuits have been repurposed for use in DC applications. However, due to the unique characteristics of DC circuits and the way current flows through them, in relation to AC circuits, identical AC fuses often are rated for much lower voltages in DC applications than they would be for AC applications. This can result in expensive and often suboptimal fuse operation. Therefore, there exists a need for fuses designed for high-power DC applications that takes into account the unique characteristics of DC circuits.

In the case of battery powered vehicles, when a fault occurs in the direct current circuit, the current rises exponentially with a time constant equal to the inductance L to the resistance R present in the circuit, according to the following formula:

$$i = \frac{U}{R} - {I}_{0} {e}^{- \frac{Rt}{L}}$$

In which l₀ is the current in the circuit at the instant of fault initiation. In the majority of circuits, the time constants are in the range of 5-50 ms. As a result, the power inputs to fuse elements rise relatively slowly after the occurrence of faults, the rate of rise decreasing corresponding to the increase of the circuit time constant. The time taken to cause melting of fuse elements can therefore be considerably greater than those which would occur if symmetrical sinusoidal currents with the same RMS values as the prospective DC values (U/R) flowed.

The above effect increases with the prospective current, when the prearcing times are short relative to the circuit time constants. The longer pre-arcing times associated with high prospective direct currents in circuits with long time constants allow more energy to be dissipated from the fuse elements to the surrounding and therefore the l²t inputs required to cause melting are somewhat higher than those required for the same prospective alternating currents. The l²t inputs at particular values of direct current do not, however, rise in direct proportion to the pre-arcing times, because of the relatively slow rises of the direct currents after faults occur.

After melting of one or more of the restrictions in a fuse element has occurred, arcing commences, causing erosion of the element material and lengthening of the arc or arcs. In direct current applications, however, there are no natural current zeros at which arc extinctions can occur and therefore the arcs must continue to lengthen until the voltage drops across them cause the currents to fall to very low levels at which point arc extinction can occur. As a result, the arcing durations and total operating times of fuses used in direct current circuits increase with the circuit supply voltages; also the time constants of the circuits increase because the circuit inductance reduces the rate of current reduction.

Because of the above factors, manufacturers often reduce the voltage ratings of AC fuselinks which are to be used in DC circuits and they relate the voltage ratings to the circuit time constant. It will be appreciated from the above that the l²t input needed to cause operation of a fuse at a high direct current is higher than that required to interrupt an alternating current of the same RMS value.

### SUMMARY OF THE INVENTION

This and other unmet needs of the prior art are met by a device as described in more detail below.

The fuse includes a fusible element comprising a fusible material in electrical contact with a pair of fuse links. The terminal elements of the fuse links are tensioned away from the fusible element such that when the fusible material melts, the tension force will extract the terminal elements from the fuselink causing interruption of the circuit. The tension reduces the response time of fuse in the event of a short circuit. The fuse links may be comprised of a metal with a coating of another metal or alloy to prevent oxidation of the fusible material. The terminal portions of the fuse links may have a reduced cross-section relative to the other portions of the fuse links, comprising, for example, an aperture therethrough.

In an embodiment, a fuse is comprised of two fuse links connected in parallel. The fuse links are substantially identical and include tensioning means or springs adapted to pull the terminal ends of the fuse links away from the fusible material in the event of a short circuit. This may be accomplished by the melting of the fusible material during a period of high current. The tension in the springs is such that the shape of the fuse links is not affected by the force, but during periods of high current flow and corresponding melting of the fusible material, the springs pull the terminal portion of the fuse links away, hastening arc extinction and circuit break. A surface of the fuse links may be coated with an alloy to prevent oxidation of the fusible material prior to short circuit. The areas of reduced cross-section may be achieved with apertures through the material of the fuse links, the apertures may have different geometrical forms, i.e. circles, rectangles, squares, rhombus, etc., with specific diameters depending on rated current and short-circuits to be cleared.

### BRIEF DESCRIPTION OF THE DRAWINGS

A better understanding of the exemplary embodiments of the invention will be had when reference is made to the accompanying drawings, wherein identical parts are identified with identical reference numerals, and wherein:

FIG. 1 is a side view of a fuse link.

FIG. 2 is a side view of two fuse links positioned in parallel.

FIG. 3 is a rear elevation view of a fuse link.

FIG. 4 is perspective view of a fuse link.

FIG. 5 is a bottom perspective view of a fuse link.

FIG. 6 is a perspective view of a fuse employing two fuse links in parallel.

FIG. 7 is a perspective view of an embodiment of a fuse link.

### DETAILED DESCRIPTION

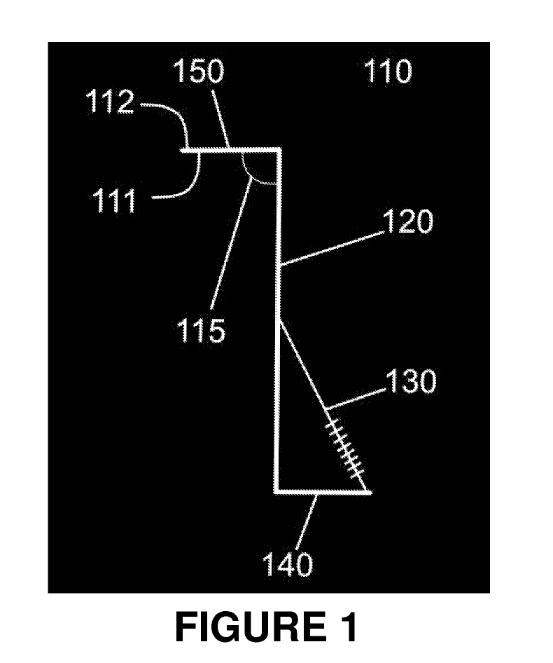

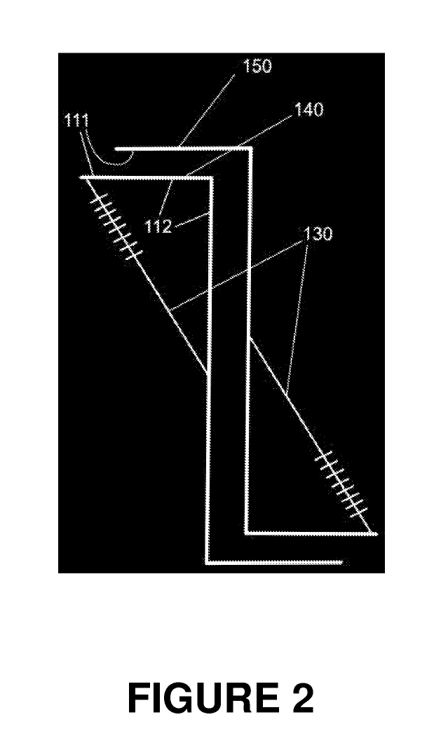

Turning to the drawings for a better understanding, FIG. 1 shows a side view of a fuse link 110. The fuse link is comprised of a central portion 120, a first terminal portion 140, a second terminal portion 150 and a tensioning means 130. The terminal portions are deflected out of the plane of the central portion by an angle 115. The fuse link has a first surface 111 and a second surface 112. The first surface is the internal surface when 2 fuse links are employed in parallel as will be shown in FIG. 2. It is clear from FIG. 1 that the fuse link is bent out of the plane of the central portion in two equal and opposite directions, by an angle 115. The fuse link in this FIGURE is generally Z shaped with the angle 115 between the terminal portions and the central portion being in the range of from about 75 to about 100 degrees. Preferably, this angle is approximately 90 degrees. This arrangement of the terminal portions and their symmetrical relationship about the central portion allows them to be employed in parallel as will be shown below.

As can be seen from FIG. 2, in an embodiment, two fuse links are positioned opposing each other. The two fuse links are positioned such that their respective first surfaces 111 face each other and their second surfaces 112 face outside the arrangement. It is clear from FIG. 2 that the second fuse link has been rotated 180 degrees from the first fuse link. This 180 degree rotation positions the first terminal portion 140 of one fuse link proximate to the second terminal portion 150 of the other fuse link. This is apparent by the position of the tensioning means. It is clear from the drawing that the tensioning means are positioned to pull the first terminal portion 140 of each fuse link away from the second terminal portion of the other fuse link. In an embodiment, the tensioning means are springs. The tensioning means 130 operate to decrease the total operating time of the fuse when a short circuit occurs. The force applied by the tensioning means is such that it does not influence the geometrical form of the fuse during normal current conditions, but is sufficient to increase arc length upon melting of the fusible material and thus decrease the operating time of the fuse during a current rise.

In an embodiment, both fuse link surfaces are coated with an alloy to prevent or slow oxidation of the fusible element (which may be for example copper). In a preferred embodiment, the alloy is a tin alloy. In conventional fuse links filler material insulates the fuse links increasing any heating effects from the current flowing through the fuse. Here, the tin alloy situated at the interior of the fuse links (more specifically on the first surfaces) will degrade from the surface. The tin alloy pealing process will decrease the cross-section of the fuse link which in turn will increase the local temperature and further the process. At this stage the liquid cooper will be the subject of the same electrodynamic forces and therefore will leave the fuse link in a cascade process. Once the copper from the reduced cross section areas will melt (or will be close to melt) the springs forces will extract the middle part from the fuse link circuit (the part located between the holes) causing the interruption of the circuit. As a result of the combined spring action and geometry design (size and hole distance), the separation distance between the fuse terminals can be one order of magnitude higher than in a conventional fuse. This has a proportional impact in increasing the voltage limits e.g. kilovolts over hundred of volts. Furthermore the interruption can occur with only a limited quantity of copper melt, therefore decreasing the reaction time and increasing the current limiting effects.

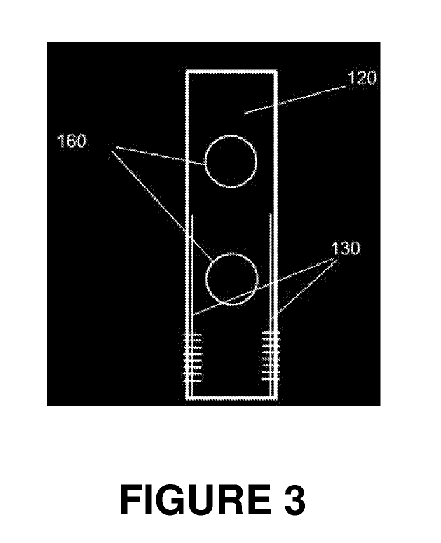

FIG. 3 shows a rear elevation view of a fuse link. The second surface of the central portion 120 is displayed along with twin tensioning means. Furthermore, in this FIGURE apertures 160 are shown, the apertures are defined by the central portion. The apertures create a reduced cross-section for the current to flow across. Of course, the reduced cross-section may have different geometrical forms, i.e. rectangles, squares, rhombus, etc., with specific diameters depending on rated current and short-circuits to be cleared. It is clear from this figure that a pair of springs are employed in this embodiment, at each end of fuselinks, in order to decrease the total operating time of the fuse when a short-circuit occurs. The springs are pre-tensioned but the total force doesn't influence the geometrical form of the fuse during normal operating conditions.

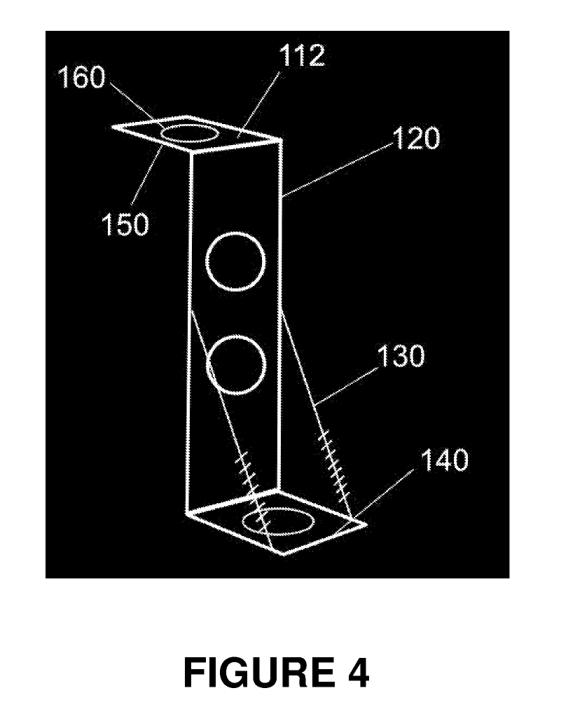

FIG. 4 is a perspective view of a fuse link. From this view the second surface side of the fuse link, including the first terminal portion 140 and second terminal portion 150, is displayed. Additionally, from this view, apertures 160 can be seen on the first and second terminal portions. As was seen in FIG. 3, the central portion has 2 apertures in this embodiment. The tensioning means 130 are displayed attached to the central portion 120 and the first terminal portion. In this embodiment, the tensioning means are attached along the second surface side of the fuse link.

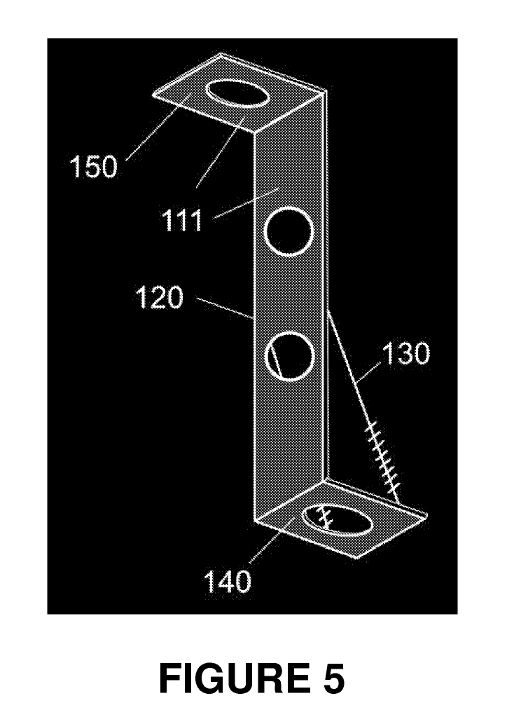

FIG. 5 is a bottom perspective view of a fuse link. The first surface 111 side of the fuse link, including the first terminal portion 140, the central portion 120 and the second terminal portion, is apparent. Again, the tensioning means are displayed attached to the central portion 120 and the first terminal portion 140. The first surface may be coated with a tin alloy. In conventional fuse links filler material insulates the fuse links increasing any heating effects from the current flowing through the fuse. Here, the tin alloy situated at the interior of the fuse links (more specifically on the first surfaces) will degrade from the surface. The tin alloy pealing process will decrease the cross-section of the fuse link which in turn will increase the local temperature and further the process. At this stage the liquid cooper will be the subject of the same electrodynamic forces and therefore will leave the fuse link in a cascade process. Once the copper from the reduced cross section areas will melt (or will be close to melt) the springs forces will extract the middle part from the fuse link circuit (the part located between the holes) causing the interruption of the circuit. As a result of the combined spring action from the tensioning means 130 and the geometry design (size and hole distance of the apertures) of the fuse link, the separation distance between the fuse terminals can be one order of magnitude higher than in a conventional fuse. This has a proportional impact in increasing the voltage limits e.g. kilovolts over hundred of volts. Furthermore the interruption can occur with only a limited quantity of copper melt, therefore decreasing the reaction time and increasing the current limiting effects.

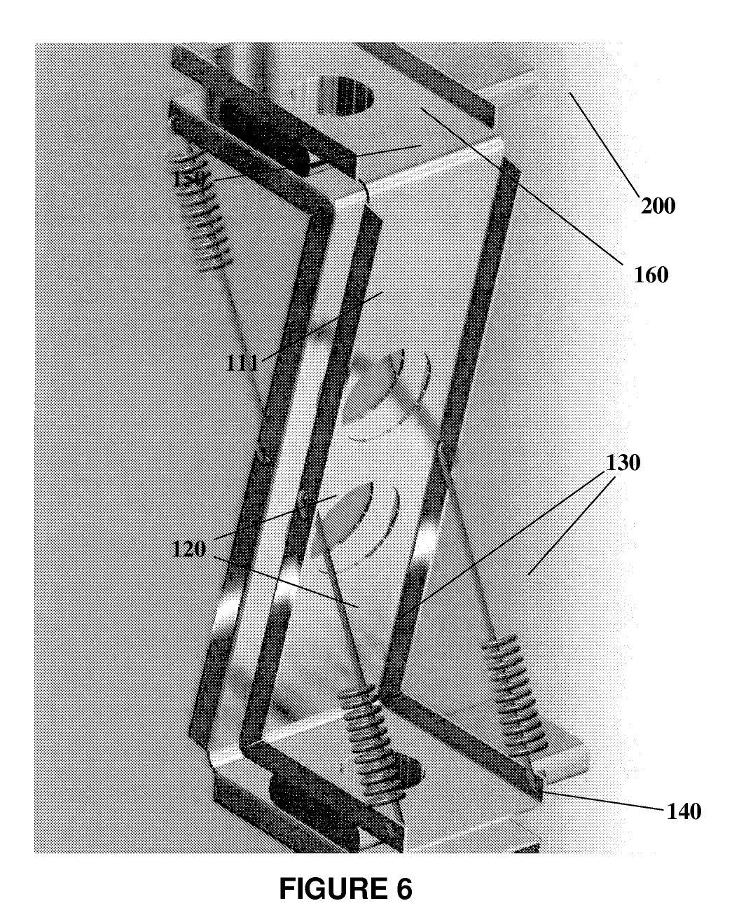

FIG. 6 shows an embodiment of a fuse comprising two fuse links arranged in parallel. The fuse links are connected about fusible material 200. The fusible material is positioned between the first terminal portion 140 of one fuse link and the second terminal portion 150 of the other fuse link. This same arrangement is present at both ends of the fuse. It is clear that the fusible material contacts the fuse links on the first surface 111. The tensioning means 130 are shown attached to the first terminal portion 140 and the central portion of each fuse link. The tensioning means serve to provide mechanical force to draw the first terminal portion of the respective fuse link away from the fusible material during increased current rate and corresponding melt of the fusible material. The mechanical force applied by the tensioning means serves to shorten the time between current increase (above rated levels) and operation of the fuse by further lengthening the resulting arcs. Once again, apertures 160 are shown to provide areas of reduced cross-section for the current to flow across. Of course, the reduced cross-section may have different geometrical forms, i.e. circles, rectangles, squares, rhombus, etc., with specific diameters depending on rated current and short-circuits to be cleared. The portion of the fuse links that contact the fusible material may be coated with an alloy. A preferred alloy would be a tin alloy. Alternatively, the fuse may include shims (not pictured) to keep the fuse links at a predetermined distance from one another. The distance between the fuse links may be altered, for example with shims, to achieve an appropriate time constant.

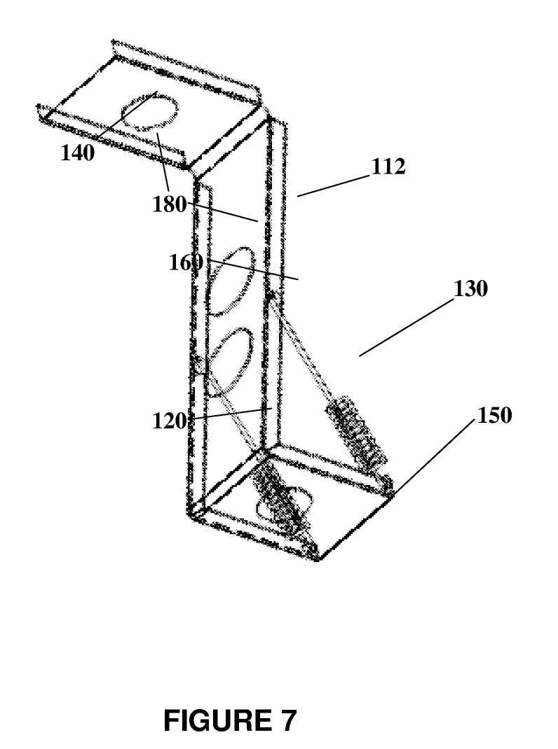

FIG. 7 shows a perspective view of an embodiment of a fuse link. The fuse link has the first terminal portion 140 and a second terminal portion 150 about the central portion. Apertures 160 can be seen on all three portions. Tensioning means 130 are connected to the second terminal portion and the central portion. In this embodiment, the tensioning means are connected to side flanges 180. The side flanges 180 run along the lateral side of the first terminal portion, the second terminal portion and the central portion. It is clear from this figure that the flanges are angled toward the second surface 112 side of each portion of the fuse link. The flanges not only provide a convenient attachment point for attachment means, the flanges provide structural strength to the fuse link to prevent external forces that might arise during operation from distorting the shape of the fuse link. The flanges may be comprised of the same material that makes up the fuse link.

Having shown and described an embodiment of the invention, those skilled in the art will realize that many variations and modifications may be made to affect the described invention and still be within the scope of the claimed invention. Additionally, many of the elements indicated above may be altered or replaced by different elements which will provide the same result and fall within the spirit of the claimed invention. It is the intention, therefore, to limit the invention only as indicated by the scope of the claims.

What is clamed is:

1. An electric fuse comprising:
two fuse links, the fuse links having a central portion, a first terminal portion, a second terminal portion on the opposite end of the central portion, the fuse link having a first surface, and a second surface opposite of the first surface, the central portion defines a plane, the first terminal portion deflected from the plane at an angle such that the second surface of the first terminal portion is closer to the second surface of the central portion, the second terminal portion deflected from the plane at an angle such that the first surface of the second terminal portion is closer to the first surface of the central portion;
a fusible element;
the fuse links connected in parallel about the fusible element;
tensioning means positioned to separate the first surface of a fuse link from the fusible element during short circuit.

2. The fuse of claim 1, wherein the first surface of the fuse links is coated with an alloy.

3. The fuse of claim 2, wherein the alloy is a tin alloy.

4. The fuse of claim 1, wherein the tensioning means is a spring.

5. The fuse of claim 1, wherein the tensioning means is attached to the first terminal portion and the central portion.

6. The fuse of claim 1 further comprising an area of reduced cross-section in the first terminal portion.

7. The fuse of claim 1 further comprising an area of reduced cross-section in the second terminal portion.

8. The fuse of claim 1 further comprising lateral flanges running substantially the length of each portion of the fuse links.

9. The fuse of claim 6 wherein the area of reduced cross-section defines an aperture therethrough in the shape of a circle.

10. The fuse of claim 1, wherein the fuse links are generally z-shaped and the angle of deflection from the plane of the central portion is approximately 90 degrees.

11. The fuse of claim 10 wherein the fuse links are positioned in a symmetrical arrangement with the first surface of the fuse links opposing each other.

12. An electric fuse comprising:
two fuse links, the fuse links having a central portion, a first terminal portion, a second terminal portion on the opposite end of the central portion, each fuse link having a first surface, and a second surface opposite the first surface, the first terminal portion bent such that the second surface of the first terminal portion is closer to the second surface of the central portion, the second terminal portion bent such that the first surface of the second terminal portion is closer to the first surface of the central portion;
a fusible element;
the fuse links connected in parallel about the fusible element;
a coating of an alloy on the first surface of at least the terminal portion of the fuse links;
springs attached to the central portion and the first terminal portion adapted to separate the first surface of a fuse link from the fusible element during short circuit;
apertures defined by the terminal portions in the shape of a circle to provide an area of reduced cross-section; and
wherein the fuse links are positioned in a symmetrical arrangement with the first surface of the fuse links opposing each other.

13. The fuse of claim 12, wherein the fuse links are generally z-shaped and the angle of deflection from the plane of the central portion is approximately 90 degrees.

14. A fuse link comprised of an elongated strip of a metal bent into a generally z-shape; the fuse link having a first surface and a second surface; tensioning means attached to a central portion of the fuse link and adapted to provide a mechanical force pulling one end of the z-shape toward the central portion; and lateral flanges running substantiall the length of each portion of the z-shape.

15. The fuse link of claim 14 wherein the tensioning means pulls the second surface of the end closer to the second surface of the central portion.

16. The fuse link of claim 14 wherein the first surface is coated with an alloy.

17. The fuse link of claim 15 wherein the alloy slows oxidation during operation of the fuse link.

18. The fuse link of claim 14 wherein apertures are defined by the ends and the central portion to provide areas of reduced cross-sectional area.

19. The fuse link of claim 18 wherein the first surface is coated with an alloy.

20. The fuse link of claim 19 wherein the alloy is a tin alloy.
